(19) United States
(12) Patent Application Publication
(10) Pub. No.: US 2026/0340770 A1
(43) Pub. Date: Oct. 29, 2026

(54) IMAGE PROCESSING SYSTEMS, IMAGE PROCESSING METHODS, NON-TRANSITORY COMPUTER READABLE RECORDING MEDIUM WITH STORED PROGRAM, AND NON-TRANSITORY COMPUTER PROGRAM PRODUCT

(71) Applicant: REALTEK SEMICONDUCTOR CORP., HsinChu (TW)

(72) Inventors: Yu-Cheng Cheng, HsinChu (TW); Jia-Wei Wu, HsinChu (TW); Yu-An Chang, HsinChu (TW)

(73) Assignee: REALTEK SEMICONDUCTOR CORP., HsinChu (TW)

(21) Appl. No.: 19/638,796

(22) Filed: Apr. 3, 2026

(30) Foreign Application Priority Data
Apr. 23, 2025 (TW) 114115419

(51) Int. Cl. G06T 5/20

(52) U.S. Cl. CPC G06T 5/20; G06T 2207/20028; G06T 2207/20076

(57) ABSTRACT

An image processing system, an image processing method, a non-transitory computer readable recording medium with a stored program, and a non-transitory computer program product, where the image processing method includes: receiving an input image; obtaining a previous mask image of the input image and enlarging the previous mask image to obtain a mask image, where a size of the mask image is the same as a size of the input image; performing a picture quality function on the input image through a picture quality module to obtain a picture quality image; and performing a pixel weight averaging procedure on the input image and the picture quality image based on values of each of a plurality of pixels of the mask image to obtain an output image.

### CROSS-REFERENCE TO RELATED APPLICATION

This non-provisional application claims priority under 35 U.S.C. § 119(a) to Patent Application No. 114115419 filed in Taiwan, R.O.C. on Apr. 23, 2025, the entire contents of which are hereby incorporated by reference.

### BACKGROUND

### Technical Field

The present disclosure belongs to the technical field of image processing, and in particular to a technology of local optimization of images.

### Related Art

In a multimedia chip architecture, in order to improve a picture quality (PQ) of an image, a series of picture quality functions (PQ functions) are used, such as noise reduction, sharpness adjustment, de-contouring, etc. With the change of display technology and the popularization of 4K and 8K TVs, a more accurate picture quality function is needed technically, that is, it can appropriately process a local region of the image. However, a traditional approach is usually to perform general processing on the whole picture, which has limited performance on the local region of the picture. To achieve specific range or local processing, judgment conditions need to be added first, which usually need operations of more pixels and additional circuits (such as line buffer) in data path and control logic. Since each pixel needs to be processed separately in each clock cycle, the data path will be more complicated in design, and the control logic will be more cumbersome, which will lead to an increase in circuit area.

### SUMMARY

In view of this, some embodiments of the present disclosure provide an image processing system, an image processing method, a non-transitory computer readable recording medium with a stored program, and a non-transitory computer program product to alleviate the problems in the prior art.

Some embodiments of the present disclosure provide an image processing system. The image processing system includes a processing module and a picture quality module, the picture quality module is configured to perform a picture quality function, and the processing module is configured to receive an input image and perform the following steps: (a) obtaining a previous mask image of the input image and enlarging the previous mask image to obtain a mask image, where a size of the mask image is the same as a size of the input image; (b) performing the picture quality function on the input image through the picture quality module to obtain a picture quality image; and (c) performing a pixel weight averaging procedure on the input image and the picture quality image based on values of each of a plurality of pixels of the mask image to obtain an output image.

Some embodiments of the present disclosure provide an image processing method, performed by a processing module. The image processing method includes: (a) receiving an input image; and obtaining a previous mask image of the input image and enlarging the previous mask image to obtain a mask image, where a size of the mask image is the same as a size of the input image; (b) performing a picture quality function on the input image through a picture quality module to obtain a picture quality image; and (c) performing a pixel weight averaging procedure on the input image and the picture quality image based on values of each of a plurality of pixels of the mask image to obtain an output image.

Some embodiments of the present disclosure provide a computer readable medium with a stored program and a non-transitory computer program product, which can complete the above image processing method after a processing unit loads and executes the program.

Based on the above, some embodiments of the present disclosure provide the image processing system, the image processing method, the non-transitory computer readable recording medium with a stored program, and the non-transitory computer program product. By obtaining local information of the input image from the mask image and then performing the pixel weight averaging procedure on the input image and the picture quality image using the local information of the input image, efficacies of performing a specific picture quality function on a local region of the input image can be achieved on the premise of not modifying an original architecture (e.g., circuit architecture) of the picture quality module. When the picture quality module is implemented in hardware, not modifying the original architecture of the picture quality module can avoid increasing an additional circuit area.

### BRIEF DESCRIPTION OF THE DRAWINGS

FIG. 1 is a block diagram of an image processing system according to an embodiment of the present disclosure;

FIG. 2 is a schematic flowchart of an image processing method according to some embodiments of the present disclosure;

FIG. 3 is a block diagram of the image processing system according to an embodiment of the present disclosure;

FIG. 4A is a schematic flowchart of a pixel weight averaging procedure according to some embodiments of the present disclosure;

FIG. 4B is a schematic diagram of a difference image according to some embodiments of the present disclosure;

FIG. 5 is a schematic flowchart of the image processing method according to some embodiments of the present disclosure;

FIG. 6 is a schematic system block diagram of an electronic device according to some embodiments of the present disclosure;

FIG. 7 is a flowchart of the image processing method according to some embodiments of the present disclosure;

FIG. 8 is a flowchart of the image processing method according to some embodiments of the present disclosure;

FIG. 9 is a flowchart of setting a previous mask image according to some embodiments of the present disclosure;

FIG. 10 is a flowchart of the image processing method according to some embodiments of the present disclosure;

FIG. 11 is a flowchart of the image processing method according to some embodiments of the present disclosure; and

FIG. 12 is a flowchart of the image processing method according to some embodiments of the present disclosure.

### DETAILED DESCRIPTION

The foregoing and other technical contents, features and efficacies of the present disclosure will be clearly presented in the following detailed description of embodiments with reference to the drawings. Any modification and change that does not affect the efficacies and objectives of the present disclosure shall still fall within the scope of the technical contents disclosed in the present disclosure. The same reference numerals in all drawings will be used to denote the same or similar components.

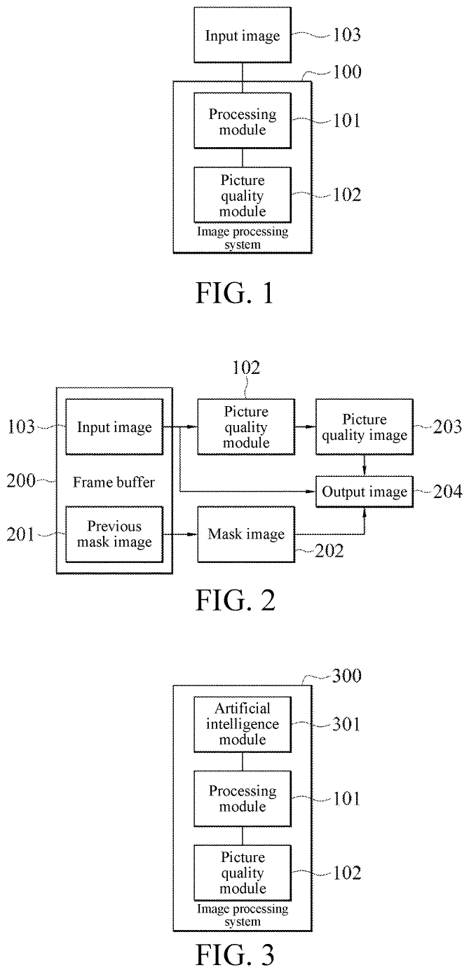

FIG. 1 is a block diagram of an image processing system according to an embodiment of the present disclosure. Referring to FIG. 1, an image processing system 100 includes a processing module 101 and a picture quality module 102. The processing module 101 is configured to obtain an input image 103. The picture quality module 102 is configured to perform a picture quality function on an image inputted into the picture quality module 102 based on an image algorithm to adjust the image inputted into the picture quality module 102. The above picture quality function is, for example, noise reduction, de-contouring, contrast adjustment, color adjustment, and sharpness adjustment. The picture quality module 102 may be implemented using circuitry or software.

The image processing method according to some embodiments of the present disclosure and how modules of the image processing system 100 cooperate with each other will be described in detail below with reference to the accompanying drawings.

FIG. 2 is a schematic flowchart of an image processing method according to some embodiments of the present disclosure. FIG. 7 is a flowchart of the image processing method according to some embodiments of the present disclosure. Referring to FIG. 1, FIG. 2, and FIG. 7, in some embodiments of the present disclosure, the image processing method includes performing steps S701 to S703 by the processing module 101. In step S701, a processing module 101 receives an input image 103 and obtains a previous mask image 201 corresponding to an input image 103. The processing module 101 temporarily stores the input image 103 and the previous mask image 201 in a frame buffer 200. The processing module 101 enlarges the previous mask image 201 to obtain a mask image 202, where a size of the mask image 202 is the same as a size of the input image 103. A pixel value of a pixel of the mask image 202 represents local information of each pixel of the input image 103.

In some embodiments of the present disclosure, the mask image 202 is an 8 bits image (that is, the pixel value of the image is stored in 8 bits), and the pixel value of the pixel of the mask image 202 represents a relative inverse depth of each pixel of the input image 103, that is, the larger the pixel value of the pixel of the mask image 202, the shallower the depth (i.e., the shorter the estimated distance from the lens). In this embodiment, the pixel value of the pixel of the mask image 202 can distinguish the input image 103 into foreground and background. In some embodiments of the present disclosure, the mask image 202 is an 8 bits image, and the pixel value of the pixel of the mask image 202 represents a category tag for what object each pixel of the input image 103 belongs to. In this embodiment, the pixel value of the pixel of the mask image 202 can distinguish the input image 103 into different objects. The mask image 202 will be further explained in the following embodiments.

In step S702, the processing module 101 performs a picture quality function on the input image 103 through the picture quality module 102 to obtain a picture quality image 203. In step S703, the processing module 101 performs a pixel weight averaging procedure on the input image 103 and the picture quality image 203 based on values of each of pixels of the mask image 202 to obtain an output image 204.

In the above embodiment, by obtaining local information of the input image 103 from the mask image 202 and then performing the pixel weight averaging procedure on the input image 103 and the picture quality image 203 using the local information of the input image 103, efficacies of performing a specific picture quality function on a local region of the input image 103 can be achieved on the premise of not modifying an original architecture (e.g., circuit architecture) of the picture quality module 102. When the picture quality module 102 is implemented in hardware, not modifying the original architecture of the picture quality module 102 can avoid increasing an additional circuit area.

Taking the above embodiment where the pixel value of the pixel of the mask image 202 represents the relative inverse depth of each pixel of the input image 103 as an example, since the larger the pixel value of the pixel of the mask image 202, the shallower the depth (i.e., the shorter the estimated distance from the lens), if the desired effect is to obtain a stronger picture quality function effect in the foreground and a weaker picture quality function effect in the background, then in the pixel weight averaging procedure, in a case of a larger pixel value of the pixel of the mask image 202, a larger weight may be given to the corresponding pixel of the picture quality image 203, and a smaller weight may be given to the corresponding pixel of the input image 103. In a case of a smaller pixel value of the pixel of the mask image 202, a smaller weight may be given to the corresponding pixel of the picture quality image 203, and a larger weight may be given to the corresponding pixel of the input image 103.

In some embodiments of the present disclosure, the processing module 101 enlarges the previous mask image 201 using a bicubic interpolation algorithm to obtain the mask image 202. In some embodiments of the present disclosure, the processing module 101 enlarges the previous mask image 201 using a nearest neighbor interpolation algorithm.

FIG. 3 is a block diagram of the image processing system according to an embodiment of the present disclosure. FIG. 8 is a flowchart of the image processing method according to some embodiments of the present disclosure. Referring to FIG. 1, FIG. 3, and FIG. 8, in some embodiments of the present disclosure, compared with the image processing system 100, the image processing system 300 further includes an artificial intelligence module 301. In this embodiment, step S701 includes step S801. In step S801, a processing module 101 obtains a previous mask image 201 of an input image 103 through an artificial intelligence module 301.

In some embodiments of the present disclosure, the artificial intelligence module 301 includes a depth information model, and in step S801, the processing module 101 obtains the previous mask image 201 corresponding to the input image 103 based on the depth information model.

In some embodiments of the present disclosure, the depth information model is a MiDaS model. The MiDaS model may calculate the relative inverse depth according to a single image, that is, the larger the value of a pixel of a depth estimation image outputted by the MiDaS model, the shallower the depth (i.e., the shorter the estimated distance from the lens). In this embodiment, the processing module 101 first reduces the input image 103 to a size of an input of the MiDaS model, and then inputs the reduced input image 103 into the MiDaS model. The processing module 101 takes an output of the MiDaS model as the previous mask image 201 corresponding to the input image 103. It is worth noting that the depth information model may also be another monocular depth estimation model. The monocular depth estimation model is, for example, Deep Ordinal Regression Network (DORN), DenseDepth, Dense Prediction Transformers (DPT), Global-Local Path Networks (GLPN) or Marigold, which is not limited by the present disclosure. DORN and DenseDepth are models established using convolutional neural networks, DPT and GLPN are transformer-based models, and Marigold is a diffusion-based model.

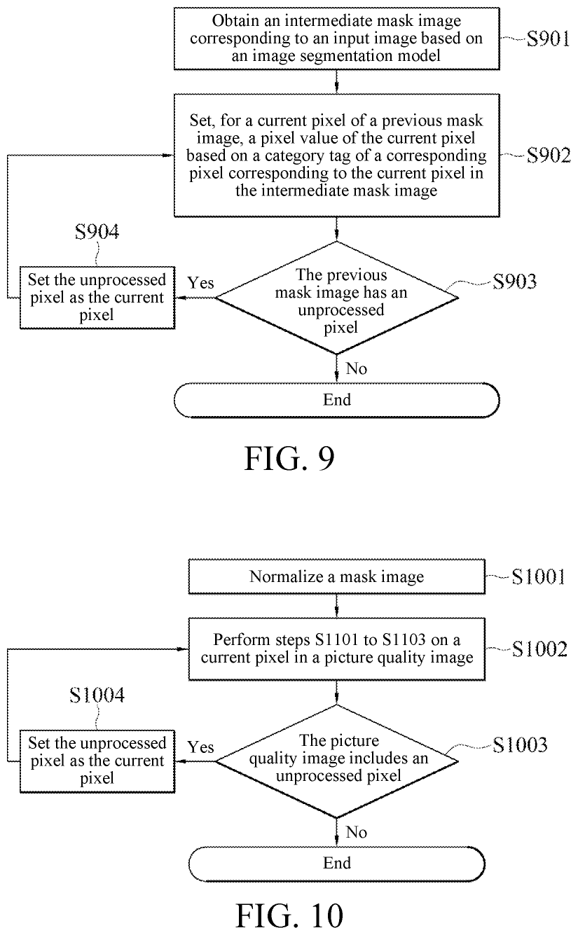

FIG. 9 is a flowchart of setting a previous mask image according to some embodiments of the present disclosure. Referring to FIG. 1, FIG. 3, and FIG. 9, in some embodiments of the present disclosure, the artificial intelligence module 301 includes an image segmentation model, and in step S801, the processing module 101 performs steps S901 to S904 to obtain the previous mask image 201 of the input image 103. In step S901, a processing module 101 obtains an intermediate mask image corresponding to an input image 103 based on an image segmentation model. Each pixel of the intermediate mask image is assigned a category tag to indicate the object to which the pixel belongs. In step S902, for a current pixel of a previous mask image 201, the processing module 101 sets a pixel value of a current pixel based on a category tag of a corresponding pixel corresponding to the current pixel in the intermediate mask image. In step S903, the processing module 101 determines whether the previous mask image 201 has an unprocessed pixel, if so, performs step S904, and if not, ends this flow. In step S904, in response to the previous mask image 201 having the unprocessed pixel, the processing module 101 sets the unprocessed pixel as the current pixel and goes back to step S902.

In some embodiments of the present disclosure, the image segmentation model is a U-Net model. In this embodiment, in step S901, the processing module 101 first reduces the input image 103 to a size of an input of the U-Net model, and then inputs the reduced input image 103 into the U-Net model. The processing module 101 takes an output of the U-Net model as the intermediate mask image corresponding to the input image 103. Each pixel of the intermediate mask image is assigned a category tag to indicate the object to which the pixel belongs. Next, in steps S902 and S903, the processing module 101 obtains the previous mask image 201 based on the intermediate mask image.

In this embodiment, a preset value is stored corresponding to each of the objects that can be recognized by the image segmentation model. For example, a preset value corresponding to a vehicle is 0.5, and a preset value corresponding to ground is 0.7. In step S902, for the current pixel of the previous mask image 201, the processing module 101 sets the pixel value of the current pixel as the preset value corresponding to the object indicated by the category tag of the corresponding pixel based on the object indicated by the category tag of the corresponding pixel corresponding to the current pixel in the intermediate mask image. The corresponding pixel corresponding to the current pixel in the intermediate mask image is the pixel in the intermediate mask image at the same position as the current pixel.

For example, the current pixel of the previous mask image 201 is a pixel at position (0, 0). Therefore, the corresponding pixel corresponding to the current pixel in the intermediate mask image is the pixel at position (0, 0) in the intermediate mask image. If the object indicated by the category tag of the corresponding pixel corresponding to the current pixel in the intermediate mask image is a vehicle, then the processing module 101 sets the pixel value of the current pixel (the pixel at position (0, 0) in the previous mask image 201) as 0.5.

It is worth noting that the image segmentation model may also be an FCN model, a DeconvNet model, a SegNet model, a DeepLab model, a RefineNet model, a PSPNet model or a GSCNN model, which is not limited by the present disclosure.

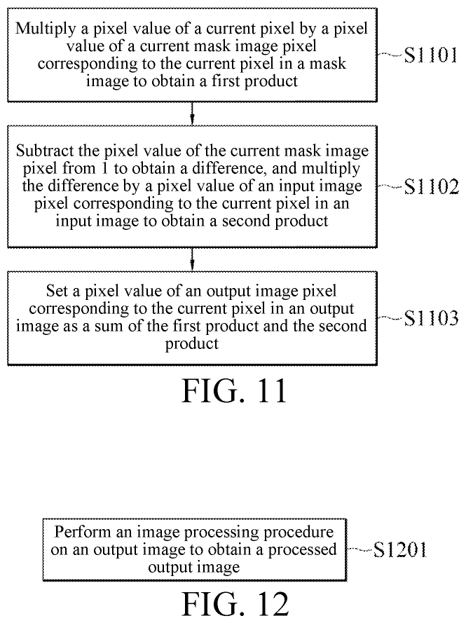

FIG. 10 and FIG. 11 are flowcharts of the image processing method according to some embodiments of the present disclosure. Referring to FIG. 2, FIG. 7, and FIG. 10 to FIG. 11, in some embodiments of the present disclosure, step S703 includes steps S1001 to S1004. In step S1001, a processing module 101 normalizes a mask image 202 such that a value of each pixel of the mask image 202 falls between 0 and 1, that is, within a closed interval [0, 1]. In step S1002, the processing module 101 performs steps S1101 to S1103 on a current pixel in a picture quality image 203. In step S1003, the processing module 101 determines whether the picture quality image 203 includes an unprocessed pixel, if so, performs step S1004, and if not, ends this flow. In step S1004, in response to the picture quality image 203 including the unprocessed pixel, the processing module sets the unprocessed pixel as the current pixel and goes back to step S1002.

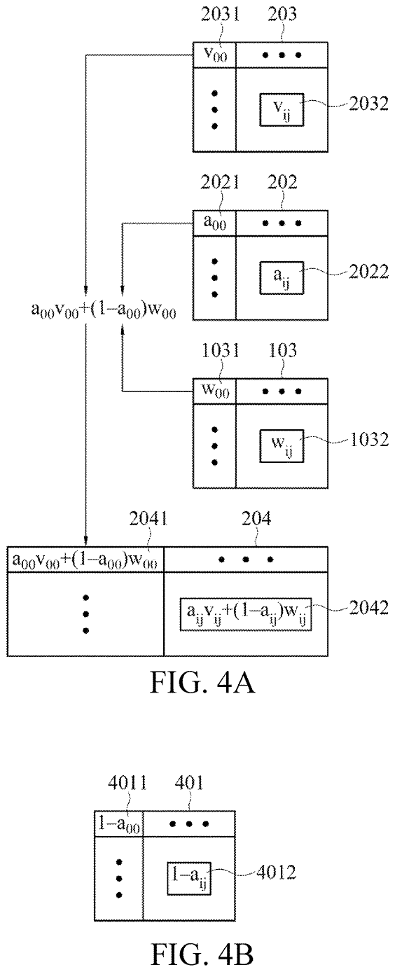

FIG. 4A is a schematic flowchart of a pixel weight averaging procedure according to some embodiments of the present disclosure. Referring to FIG. 2, FIG. 4A, FIG. 7, and FIG. 10 to FIG. 11, in step S1101, the processing module 101 multiplies a pixel value of the current pixel in the picture quality image 203 by a pixel value of a current mask image pixel corresponding to the current pixel in the mask image 202 to obtain a first product. For example, the current pixel in the picture quality image 203 is pixel 2031, and the position of pixel 2031 in the picture quality image 203 is (0, 0). The pixel at position (0, 0) in the mask image 202 is pixel 2021, so the current mask image pixel corresponding to the current pixel in the mask image 202 is pixel 2021. Since the pixel value of pixel 2031 is v₀₀ and the pixel value of pixel 2021 is a₀₀, the first product is a₀₀·v₀₀.

In step S1102, the processing module 101 subtracts the pixel value of the current mask image pixel from 1 to obtain a difference, and multiplies the difference by a pixel value of an input image pixel corresponding to the current pixel in the input image 103 to obtain a second product. In the above example, the current mask image pixel is pixel 2021, so the difference is 1−a00. Since the current pixel in the picture quality image 203 is pixel 2031, the position of pixel 2031 in the picture quality image 203 is (0, 0). The pixel at position (0, 0) in the input image 103 is pixel 1031, so the input image pixel corresponding to the current pixel in the input image 103 is pixel 1031. Since the pixel value of pixel 1031 is w₀₀, the second product is (1−a₀₀)·w₀₀.

In step S1103, the processing module 101 sets a pixel value of an output image pixel corresponding to the current pixel in the output image 204 as a sum of the first product and the second product. In the above example, the current pixel in the picture quality image 203 is pixel 2031, the position of pixel 2031 in the picture quality image 203 is (0, 0). The pixel at position (0, 0) in the output image 204 is pixel 2041, so the output image pixel corresponding to the current pixel in the output image 204 is pixel 2041. The processing module 101 sets the pixel value of pixel 2041 as a₀₀·v₀₀+(1−a₀₀)·w₀₀.

For another example, the current pixel in the picture quality image 203 is pixel 2032, and the position of pixel 2032 in the picture quality image 203 is (i, j), where i and j are both nonnegative integers. The pixel at position (i, j) in the mask image 202 is pixel 2022, so the current mask image pixel corresponding to the current pixel in the mask image 202 is pixel 2022. Since the pixel value of pixel 2032 is vᵢⱼ and the pixel value of pixel 2022 is aᵢⱼ, the first product is aᵢⱼ·vᵢⱼ. The current mask image pixel is pixel 2022, so the difference is 1−aᵢⱼ . The pixel at position (i, j) in the input image 103 is pixel 1032, so the input image pixel corresponding to the current pixel in the input image 103 is pixel 1032. Since the pixel value of pixel 1032 is wᵢⱼ, the second product is (1−aᵢⱼ )·wᵢⱼ . The pixel at position (i, j) in the output image 204 is pixel 2042, so the output image pixel corresponding to the current pixel in the output image 204 is pixel 2042. The processing module 101 sets the pixel value of pixel 2042 as aᵢⱼ·vᵢⱼ+(1−aᵢⱼ )·wᵢⱼ .

In this embodiment, the pixel weight averaging procedure includes steps S1002 to S1004.

In the above embodiment where the mask image 202 is the 8bits image and the pixel value of the pixel of the mask image 202 represents the relative inverse depth of each pixel of the input image 103, in step S1001, the processing module 101 obtains a maximum pixel value max and a minimum pixel value min of the pixels in the mask image 202. The processing module 101 subtracts min from the pixel value of each pixel of the mask image 202 and multiplies the obtained difference by 1/(max−min) to obtain the normalized mask image 202, where values of each pixel of the normalized mask image 202 fall between 0 and 1. Since the closer the pixel value of the pixel of the mask image 202 to 1, the shallower the depth (i.e., the shorter the estimated distance from the lens), after the processing module 101 performs the flow shown in FIG. 10, the output image 204 has a stronger picture quality function effect in the foreground and a weaker picture quality function effect in the background than the input image 103.

FIG. 4B is a schematic diagram of a difference image according to some embodiments of the present disclosure. The processing module 101 can obtain the same result as performing steps S1002 to S1004 through point-by-point multiplication and addition operations of matrices. Referring to FIG. 2, FIG. 4A, FIG. 4B, FIG. 7, and FIG. 10 to FIG. 11, in some embodiments of the present disclosure, the processing module 101 subtracts the mask image 202 from a one-filled tensor (i.e., all tensor values are 1) to obtain a difference image 401. For example, in the above embodiment where the pixel value of pixel 2021 is a₀₀ and the pixel value of pixel 2022 is aᵢⱼ, the pixel at position (0, 0) in the difference image 401 is pixel 4011, and the pixel at position (i, j) in the difference image 401 is pixel 4012. The pixel value of pixel 4011 is 1−a₀₀, and the pixel value of pixel 4012 is 1−aᵢⱼ .

The processing module 101 performs point-by-point multiplication operation on the mask image 202 and the picture quality image 203 to obtain a first product image. The processing module 101 performs point-by-point multiplication operation on the difference image 401 and the input image 103 to obtain a second product image. The processing module 101 performs matrix addition operation on the first product image and the second product image to obtain the output image 204. That is, if I represents the one-filled tensor, then a relationship among the output image 204, the mask image 202⊙the picture quality image 203 and the input image 103 is output image 204=mask image 202 picture quality image 203+difference image 401⊙input image 103, where ⊙ represents point-by-point multiplication.

It is worth noting that when the input image 103 is a color image, the picture quality image 203 is also a color image, and the processing module 101 performing point-by-point multiplication operation on the mask image 202 and the picture quality image 203 (i.e., calculating mask image 202⊙picture quality image 203) means the processing module 101 performing point-by-point multiplication respectively on R, G, and B components of the picture quality image 203 with the mask image 202. The processing module 101 performing point-by-point multiplication operation on the difference image 401 and the input image 103 (i.e., calculating difference image 401⊙input image 103) means the processing module 101 performing point-by-point multiplication respectively on R, G, and B components of the input image 103 with the difference image 401.

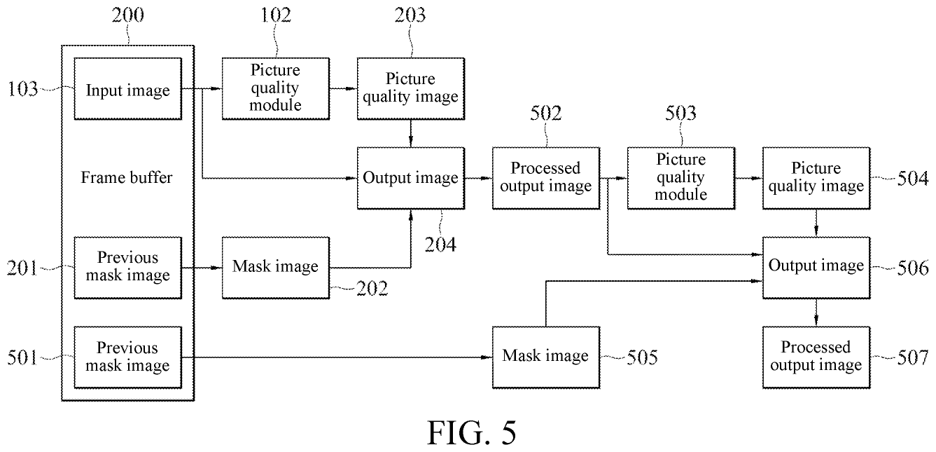

FIG. 5 is a schematic flowchart of the image processing method according to some embodiments of the present disclosure. FIG. 12 is a flowchart of the image processing method according to some embodiments of the present disclosure. Referring to FIG. 1, FIG. 5, and FIG. 12, in some embodiments of the present disclosure, the image processing method includes performing step S1201 after step S703. In step S1201, an image processing procedure is performed on an output image 204 to obtain a processed output image 502. In some embodiments of the present disclosure, the image processing procedure includes the following: the processing module 101 filters the output image 204 using a bilateral filter to make region boundaries in the output image 204 more natural.

If it is required to perform the same or a plurality of picture quality functions on a local region in the output image 204, the processing module 101 may obtain a plurality of previous mask images, and then perform the pixel weight averaging procedure on the input image 103 in stages through the information of each previous mask image. Referring to FIG. 5, in the embodiment shown in FIG. 5, after obtaining the processed output image 502, the processing module 101 obtains a previous mask image 501 and enlarges the previous mask image 501 to obtain a mask image 505. Then, the processing module 101 performs the picture quality function on the processed output image 502 through the picture quality module 503 to obtain a picture quality image 504. The processing module 101 then performs a pixel weight averaging procedure on the processed output image 502 and the picture quality image 504 based on values of each of pixels of the mask image 505 to obtain an output image 506. The processing module 101 performs an image processing procedure on the output image 506 to obtain a processed output image 507.

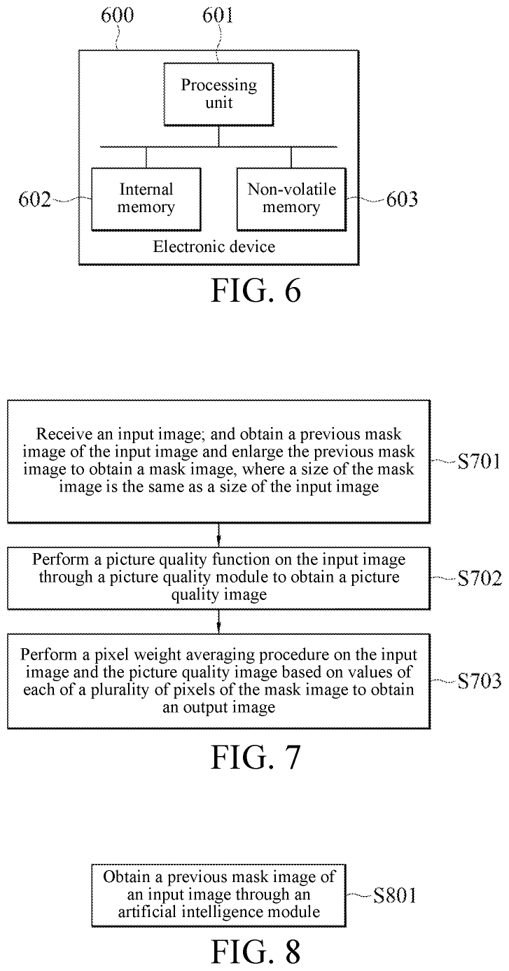

FIG. 6 is a schematic system block diagram of an electronic device according to some embodiments of the present disclosure. As shown in FIG. 6, on the hardware level, the electronic device 600 includes a processing unit 601, an internal memory 602, and a non-volatile memory 603. The internal memory 602 is, for example, a random-access memory (RAM). The non-volatile memory 603 is, for example, at least one disk memory, etc. Of course, the electronic device 600 may further include hardware required for other functions.

The internal memory 602 and the non-volatile memory 603 are configured to store programs, which may include program codes, including computer operation instructions. The internal memory 602 and the non-volatile memory 603 provide instructions and data to the processing unit 601. The processing unit 601 reads a corresponding computer program from the non-volatile memory 603 into the internal memory 602 and then runs it.

The processing unit 601 may be an integrated circuit chip having signal processing capabilities. During the implementation process, the methods and steps disclosed in the above embodiments can be completed by way of an integrated logic circuit of hardware in the processing unit 601 or instructions in the form of software. The processing unit 601 may be a general-purpose processor, including a central processing unit, a digital signal processor, an application specific integrated circuit, a field programmable gate array or other programmable logic apparatuses, and can implement or perform the methods and steps disclosed in the above embodiments.

Embodiments of this specification further provide a non-transitory computer readable storage medium. The computer readable storage medium stores at least one instruction which, when executed by a processing unit 601 of an electronic device 600, can cause the processing unit 601 of the electronic device 600 to perform the methods and steps disclosed in the above embodiments.

Examples of computer storage media include, but not limited to, a phase-change random access memory (PRAM), a static random access memory (SRAM), a dynamic random access memory (DRAM), other types of random access memories (RAMs), a read-only memory (ROM), an electrically erasable programmable read-only memory (EEPROM), a flash memory or other internal memory technologies, a compact disc read-only memory (CD-ROM), a digital versatile disc (DVD) or other optical storages, a magnetic cassette tape, a magnetic tape disc storage or other magnetic storage devices, or any other non-transmission media, which can be used for storing information that can be accessed by computing devices. As defined herein, non-transitory computer readable media do not include transitory media, such as modulated data signals and carriers.

According to the image processing system, the image processing method, the non-transitory computer readable recording medium with a stored program, and the non-transitory computer program product provided by the above embodiments, by obtaining local information of the input image from the mask image and then performing the pixel weight averaging procedure on the input image and the picture quality image using the local information of the input image, efficacies of performing a specific picture quality function on a local region of the input image can be achieved on the premise of not modifying the original architecture (e.g., circuit architecture) of the picture quality module. When the picture quality module is implemented in hardware, not modifying the original architecture of the picture quality module can avoid increasing an additional circuit area.

Although the present disclosure has been described in considerable detail with reference to certain preferred embodiments thereof, the disclosure is not for limiting the scope of the invention. Persons having ordinary skill in the art may make various modifications and changes without departing from the scope and spirit of the disclosure. Therefore, the scope of the appended claims should not be limited to the description of the preferred embodiments described above.

What is claimed is:

1. An image processing system, comprising
a picture quality module, configured to perform a picture quality function; and
a processing module, configured to receive an input image and perform the following steps:
(a) obtaining a previous mask image of the input image and enlarging the previous mask image to obtain a mask image, wherein a size of the mask image is the same as a size of the input image;
(b) performing the picture quality function on the input image through the picture quality module to obtain a picture quality image; and
(c) performing a pixel weight averaging procedure on the input image and the picture quality image based on values of each of a plurality of pixels of the mask image to obtain an output image.

2. The image processing system according to claim 1, wherein the image processing system comprises an artificial intelligence module, and the processing module obtains the previous mask image of the input image through the artificial intelligence module.

3. The image processing system according to claim 2, wherein the artificial intelligence module comprises a depth information model, and step (a) comprises: obtaining the previous mask image corresponding to the input image based on the depth information model.

4. The image processing system according to claim 2, wherein the artificial intelligence module comprises an image segmentation model, and step (a) comprises the following steps to obtain the previous mask image: (a1) obtaining an intermediate mask image corresponding to the input image based on the image segmentation model; (a2) setting, for a current pixel of the previous mask image, a pixel value of the current pixel based on a category tag of a corresponding pixel corresponding to the current pixel in the intermediate mask image; and (a3) setting, in response to the previous mask image having an unprocessed pixel, the unprocessed pixel as the current pixel, and going back to step (a2).

5. The image processing system according to claim 1, wherein step (c) comprises:
(c1) normalizing the mask image;
(c2) performing the following steps for a current pixel in the picture quality image:
(c21) multiplying a pixel value of the current pixel by a pixel value of a current mask image pixel corresponding to the current pixel in the mask image to obtain a first product;
(c22) subtracting the pixel value of the current mask image pixel from 1 to obtain a difference, and multiplying the difference by a pixel value of an input image pixel corresponding to the current pixel in the input image to obtain a second product; and
(c23) setting a pixel value of an output image pixel corresponding to the current pixel in the output image as a sum of the first product and the second product; and
(c3) setting, in response to the picture quality image comprising an unprocessed pixel, the unprocessed pixel as the current pixel, and going back to step (c2).

6. The image processing system according to claim 1, wherein the processing module is configured to perform the following step after step (c): performing an image processing procedure on the output image to obtain a processed output image.

7. The image processing system according to claim 6, wherein the image processing procedure comprises: filtering the output image using a bilateral filter.

8. An image processing method, performed by a processing module, the image processing method comprising:
(a) receiving an input image; obtaining a previous mask image of the input image and enlarging the previous mask image to obtain a mask image, wherein a size of the mask image is the same as a size of the input image;
(b) performing a picture quality function on the input image through a picture quality module to obtain a picture quality image; and
(c) performing a pixel weight averaging procedure on the input image and the picture quality image based on values of each of a plurality of pixels of the mask image to obtain an output image.

9. The image processing method according to claim 8, wherein step (a) comprises:
obtaining the previous mask image of the input image through an artificial intelligence module.

10. The image processing method according to claim 9, wherein the artificial intelligence module comprises a depth information model, and step (a) comprises: obtaining the previous mask image corresponding to the input image based on the depth information model.

11. The image processing method according to claim 9, wherein the artificial intelligence module comprises an image segmentation model, and step (a) comprises the following steps to obtain the previous mask image: (a1) obtaining an intermediate mask image corresponding to the input image based on the image segmentation model; (a2) setting, for a current pixel of the previous mask image, a pixel value of the current pixel based on a category tag of a corresponding pixel corresponding to the current pixel in the intermediate mask image; and (a3) setting, in response to the previous mask image having an unprocessed pixel, the unprocessed pixel as the current pixel, and going back to step (a2).

12. The image processing method according to claim 8, wherein step (c) comprises:
(c1) normalizing the mask image;
(c2) performing the following steps for a current pixel in the picture quality image:
(c21) multiplying a pixel value of the current pixel by a pixel value of a current mask image pixel corresponding to the current pixel in the mask image to obtain a first product;
(c22) subtracting the pixel value of the current mask image pixel from 1 to obtain a difference, and multiplying the difference by a pixel value of an input image pixel corresponding to the current pixel in the input image to obtain a second product; and
(c23) setting a pixel value of an output image pixel corresponding to the current pixel in the output image as a sum of the first product and the second product; and
(c3) setting, in response to the picture quality image comprising an unprocessed pixel, the unprocessed pixel as the current pixel, and going back to step (c2).

13. The image processing method according to claim 8, wherein the image processing method comprises performing the following step after step (c): performing an image processing procedure on the output image to obtain a processed output image.

14. The image processing method according to claim 13, wherein the image processing procedure comprises: filtering the output image using a bilateral filter.

15. A non-transitory computer readable recording medium with a stored program, completing, after a processing unit loads and executes the stored program, the method according to claim 8.

16. A non-transitory computer program product, storing at least one instruction which, when executed by a processing unit, causes the processing unit to perform the method according to claim 8.
